(19) United States
(12) Patent Application Publication
(10) Pub. No.: US 2024/0156666 A1
(43) Pub. Date: May 16, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: JUNYA SUZUKI, TOKYO (JP); MASAYUKI YOKOYAMA, TOKYO (JP)

(21) Appl. No.: 18/550,975

(22) PCT Filed: Jan. 20, 2022
(86) PCT No.: PCT/JP2022/001914

§ 371 Date: Sep. 18, 2023

(30) Foreign Application Priority Data
Mar. 25, 2021 (JP) 2021-051092

(51) Int. Cl. A61H 3/06; G01N 29/12

(52) U.S. Cl. CPC A61H 3/061; G01N 29/12; A61H 2003/063

(57) ABSTRACT

The present technology relates to an information processing apparatus, an information processing method, and a program that make it possible for a user to perceive the importance of recognition of a physical body existing in the surroundings of the user. Notification information that causes hardness of a physical body existing in a space to be perceived by a user spaced from the physical body is generated.

### TECHNICAL FIELD

The present technology relates to an information processing apparatus, an information processing method, and a program, and particularly relates to an information processing apparatus, an information processing method, and a program that make it possible for a user to perceive the importance of recognition of a physical body existing in the surroundings of the user.

### BACKGROUND ART

PTL 1 to PTL 4 disclose a technology for detecting an obstacle in front of a user and informing the user of the obstacle by sound or vibration. PTL 5 to PTL 8 disclose a technique for notifying a user of a direction of an obstacle or a destination by stereoscopic sound.

### CITATION LIST

### Patent Literature

### [PTL 1]

Japanese Patent Laid-Open No. 2017-042251

[PTL 2]

Japanese Patent Laid-Open No. Sho 57-110247

### [PTL 3]

Japanese Patent Laid-Open No. 2013-254474

### [PTL 4]

Japanese Patent Laid-Open No. 2018-192954

### [PTL 5]

Japanese Patent No. 5944840

### [PTL 6]

Japanese Patent Laid-Open No. 2002-065721

### [PTL 7]

Japanese Patent Laid-Open No. 2003-023699

### [PTL 8]

Japanese Patent Laid-Open No. 2006-107148

### SUMMARY

### Technical Problem

To such a user as a visually handicapped person or the like, it is beneficial if not only it is possible to recognize that a physical body exists in the surroundings but also it is possible to perceive the importance of recognition of the presence of the physical body.

The present technology has been made taking such a situation as just described into consideration and makes it possible for a user to recognize the importance of recognition of a physical body existing in the surroundings.

### Solution to Problem

The information processing apparatus or the program according to the present technology is an information processing apparatus including a processing unit that generates notification information that causes hardness of a physical body existing in a space to be perceived by a user spaced from the physical body, or a program for causing a computer to function as such an information processing apparatus.

The information processing method according to the present technology is an information processing method for an information processing apparatus including a processing unit, the information processing method including, by the processing unit, generating notification information that causes hardness of a physical body existing in a space to be perceived by a user spaced from the physical body.

In the information processing apparatus, information processing method, and program according to the present technology, notification information that causes hardness of a physical body existing in a space to be perceived by a user spaced from the physical body is generated.

### BRIEF DESCRIPTION OF DRAWINGS

FIG. 1 is a block diagram depicting an example of a configuration of an embodiment of an acoustic processing apparatus to which the present technology is applied.

FIG. 2 is a flow chart exemplifying a procedure of a process (notification process) performed by the acoustic processing apparatus.

FIG. 3 is a diagram exemplifying a frequency characteristic (transfer function) of a hardness filter in a case where an obstacle is hard and in another case where the obstacle is soft.

FIG. 4 is a diagram exemplifying a frequency characteristic (transfer function) of the hardness filter in a case where an obstacle is hard and in another case where the obstacle is soft.

FIG. 5 is a diagram illustrating a filter process by the hardness filter.

FIG. 6 is a diagram illustrating a case in which a filter coefficient determination unit calculates a hardness filter coefficient of the hardness filter by using an inference model.

FIG. 7 is a block diagram depicting an example of a hardware configuration of a computer that executes a series of processes by a program.

### DESCRIPTION OF EMBODIMENTS

In the following, embodiments of the present technology are described with reference to the drawings.

### First Embodiment of Acoustic Processing Apparatus

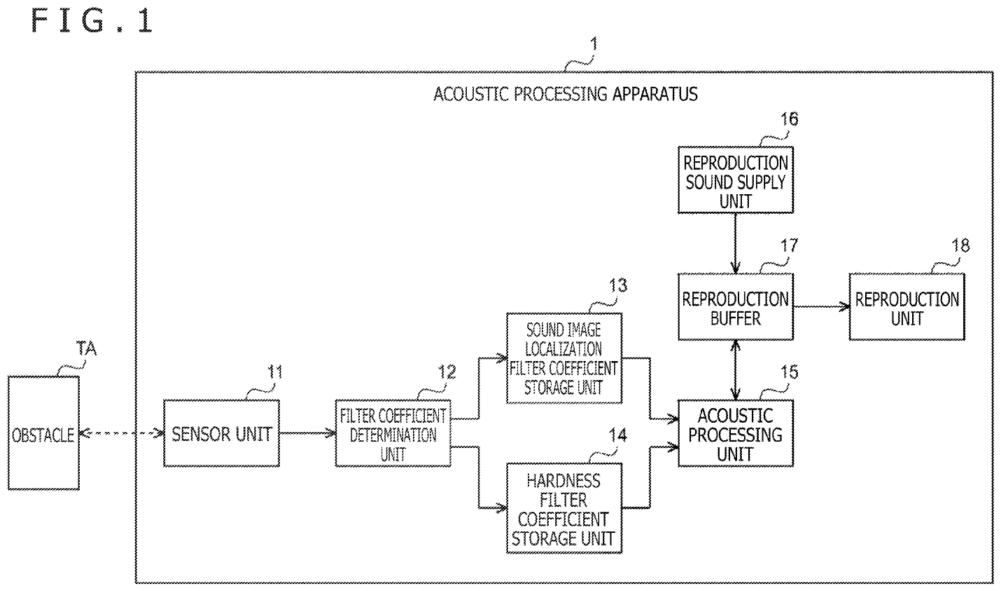

FIG. 1 is a block diagram depicting an example of a configuration of an embodiment of an acoustic processing apparatus to which the present technology is applied.

An acoustic processing apparatus 1 of the present embodiment of FIG. 1 includes an audio outputting device that converts a sound signal in the form of an electric signal into a sound wave, such as an earphone, a headphone, or a speaker. The audio outputting device may be connected to a main body of the acoustic processing apparatus 1 by wired or wireless connection, or the main body of the acoustic processing apparatus 1 may be incorporated in the audio outputting device. In the present embodiment, it is assumed that a stereo-compatible earphone is connected by wired connection to the main body of the acoustic processing apparatus 1 such that the main body of the acoustic processing apparatus 1 and the earphone constitute the acoustic processing apparatus 1.

The acoustic processing apparatus 1 generates notification information (sound signal) for causing a user to perceive through the acoustic sense that an obstacle TA (physical body spaced from the user) exists in the surroundings and, besides, perceive through the acoustic sense the importance of recognition of the presence of the obstacle TA, and presents the notification information to the user. The importance of the recognition of the presence of the obstacle TA (importance of recognition of the obstacle TA) increases as the possibility that the obstacle TA may become a disturbance to the user's walking or the like increases. For example, as the hardness of the obstacle TA increases and as the size of the obstacle TA increases, the importance of the recognition of the obstacle TA increases. It is assumed that the acoustic processing apparatus 1 of the present embodiment generates, as the notification information for notifying the user of the importance of the recognition of the obstacle TA, notification information for causing the user to perceive the hardness (feeling of hardness or softness) of the obstacle TA, and notification information for the notification of the size of the obstacle TA is suitably described supplementarily.

The acoustic processing apparatus 1 includes a sensor unit 11, a filter coefficient determination unit 12, a sound image localization filter coefficient storage unit 13, a hardness filter coefficient storage unit 14, an acoustic processing unit 15, a reproduction sound supply unit 16, a reproduction buffer 17, and a reproduction unit 18.

The sensor unit 11 detects a distance (distance from the sensor unit 11 to the obstacle TA), direction, size, and hardness of the obstacle TA existing in the surroundings of the user. The sensor unit 11 is not limited to one type of sensor and may include multiple sensors that each detect at least one detection target from among the distance, the direction, the size, and the hardness. In a case where the sensor unit 11 detects the same detection target by multiple sensors, it may merge detection results of them by using a sensor fusion technology or may preferentially adopt a detection result of any of the sensors. The sensors the sensor unit 11 has may be known sensors such as, for example, a laser distance measurement sensor, a LIDAR (Light Detection and Ranging), an ultrasonic distance measurement sensor, a radar, a ToF (Time-of-Flight) camera, a stereo camera, a depth camera, and a color sensor. Data obtained by the sensors of the sensor unit 11 (sensor data) is supplied to the filter coefficient determination unit 12. It is to be noted that the sensors of the sensor unit 11 may be spaced from the main body of the acoustic processing apparatus 1 and may be connected for communication by wireless or wired connection to the main body of the acoustic processing apparatus 1. The sensors of the sensor unit 11 may be mounted, for example, on the body of the user or may be mounted on a white cane that is used by a visually handicapped person or the like.

The filter coefficient determination unit 12 determines a filter coefficient of a digital filter (hereinafter referred to as a filter) on the basis of sensor data from the sensor unit 11. The filter coefficient is a filter coefficient of, for example, an FIR (Finite Impulse Response) filter and is a filter coefficient to be convoluted into reproduction sound hereinafter described (reproduction sound on which notification information to be presented to the user is based).

The filter whose filter coefficient is determined by the filter coefficient determination unit 12 has a frequency characteristic of an audio frequency band and outputs an impulse response of audible sound in response to an input of an impulse. A frequency function indicative of a frequency characteristic of a filter is a transfer function of the filter, and the transfer function corresponds to a function of the frequency obtained by performing Fourier transform of the impulse response of the filter from a time domain representation into a frequency domain representation. In a case where reproduction sound is filter-processed by a filter, a signal that is obtained by multiplication of same frequency components of the reproduction sound and the frequency characteristic (transfer function) of the filter (reproduction sound obtained after the filter process) is generated. Accordingly, notification information in which the frequency components of the reproduction sound (magnitude and phase of the frequency components) are changed by the filter is generated. This filter process corresponds to a process of convolution integral of the reproduction sound and the impulse response of the filter. The filter coefficient of the filter is a digital value extracted, in a sampling period same as that of the reproduction sound inputted to the filter, from the impulse response of the filter, and the convolution integral of the reproduction sound and the impulse response of the filter is convolution integral of the reproduction sound and the filter coefficient of the filter. The filter process by the filter for the reproduction sound in the acoustic processing unit 15 may be a process based on either a method that uses frequency components (frequency spectrum) of the reproduction sound and the transfer function of the filter or another method that uses the reproduction sound and the impulse response of the filter.

As the filter coefficient of the filter to be determined by the filter coefficient determination unit 12, there are a filter coefficient (referred to as a sound image localization filter) of a filter (referred to as a sound image localization filter) that gives, to the reproduction sound, an acoustic effect of causing a three-dimensional position of an obstacle TA to be perceived as the position of a sound image and a filter coefficient (referred to as a hardness filter coefficient) of a filter (referred to as a hardness filter) that gives, to the reproduction sound, an acoustic effect according to the hardness of the obstacle TA (acoustic effect of causing the hardness of the obstacle TA to be perceived).

The filter coefficient determination unit 12 detects the distance, direction, size, and hardness of the obstacle TA on the basis of sensor data obtained from the sensor unit 11.

The filter coefficient determination unit 12 calculates a sound image localization filter coefficient on the basis of the detected distance, direction, and size of the obstacle TA. The filter coefficient determination unit 12 supplies the sound image localization filter coefficient storage unit 13 with the determined sound image localization filter coefficient.

The filter coefficient determination unit 12 calculates a hardness filter coefficient on the basis of the detected hardness of the obstacle TA. The filter coefficient determination unit 12 supplies the hardness filter coefficient storage unit 14 with the determined hardness filter coefficient.

The sound image localization filter coefficient storage unit 13 stores the sound image localization filter coefficient supplied thereto from the filter coefficient determination unit 12 and supplies it to the acoustic processing unit 15.

The hardness filter coefficient storage unit 14 stores the sound image localization filter coefficient supplied thereto from the filter coefficient determination unit 12 and supplies it to the acoustic processing unit 15.

The acoustic processing unit 15 constructs a digital filter (referred to as a sound image localization filter) that uses the sound image localization filter coefficient read out from the sound image localization filter coefficient storage unit 13 and another digital filter (referred to as a harness filter) that uses the sound image localization filter read out from the hardness filter coefficient storage unit 14.

The acoustic processing unit 15 reads out reproduction sound for a predetermined period of time temporarily stored in the reproduction buffer 17 and performs, for the read out reproduction sound, a filter process with the sound image localization filter and a filter process with the hardness filter. By the processes, the acoustic processing unit 15 gives, to the reproduction sound, an acoustic effect of causing the three-dimensional position of the obstacle TA to be perceived as the position of a sound image and another acoustic effect according to the hardness of the obstacle TA (acoustic effect of causing the harness of the obstacle TA to be perceived). The acoustic processing unit 15 updates (overwrites) the original reproduction sound stored in the reproduction buffer 17 with the reproduction sound to which the acoustic effects have been given.

The reproduction sound supply unit 16 supplies the reproduction buffer 17 with reproduction sound for a predetermined period of time to be presented to the user. The reproduction sound (signal) is a digital signal sampled in a predetermined sampling period with respect to an analog signal. The reproduction sound is stereo reproduction sound including reproduction sound (R) for the right (right ear) and reproduction sound (L) for the left (left ear). In a case where the reproduction sound (R) and the reproduction sound (L) are not particularly distinguished from each other, each of them is referred to simply as reproduction sound. When reproduction sound stored in the reproduction buffer 17 is supplied, from the oldest, to the reproduction unit 18 and deleted from the reproduction buffer 17, the reproduction sound supply unit 16 supplies the reproduction buffer 17 with new reproduction sound.

The reproduction sound may be, for example, a sound signal preserved in advance in a memory not depicted. The reproduction sound preserved in the memory may be a sound signal of continuous or intermittent sound specialized as notification sound for the notification of a space situation or the like. For example, the reproduction sound may be a sine wave including a single frequency or multiple frequencies, steady noise such as white noise, or the like. The reproduction sound may be a sound signal of music or the like selected and listened to by the user. The reproduction sound may be a sound signal of music or the like supplied as streaming from an external apparatus connected to the acoustic processing apparatus 1 via a network such as the Internet.

The reproduction buffer 17 temporarily stores reproduction sound supplied from the reproduction sound supply unit 16. The reproduction buffer 17 supplies the acoustic processing unit 15 with the reproduction sound from the reproduction sound supply unit 16 for every predetermined period of time and updates the original reproduction sound with the reproduction sound (referred to as reproduction sound obtained after the acoustic process) to which the acoustic effects have been given by the acoustic processing unit 15. The reproduction buffer 17 supplies the reproduction unit 18 with the reproduction sound obtained after the acoustic process, in the chronological order (from the oldest).

The reproduction unit 18 includes an earphone that is one form of the audio outputting device. The reproduction unit 18 acquires reproduction sound obtained after the acoustic process in the chronological order from the reproduction buffer 17 and converts the reproduction sound from a digital signal into an analog signal. The reproduction unit 18 converts the reproduction sound (R) and the reproduction sound (L) obtained after conversion into analog signals, into sound waves by earphones mounted on the right ear and the left ear of the user, respectively, and outputs the sound waves.

### Processing Procedure of Acoustic Processing Apparatus 1

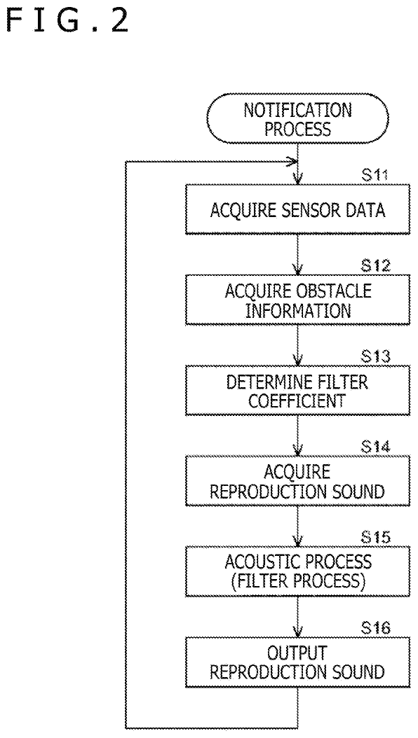

FIG. 2 is a flow chart exemplifying a procedure of the process (notification process) performed by the acoustic processing apparatus 1.

In step S11, the sensor unit 11 acquires sensor data for detecting the distance, direction, size, and hardness of the obstacle TA. The processing advances from step S11 to step S12.

In step S12, the filter coefficient determination unit 12 detects (acquires) the information regarding the obstacle TA, namely, the distance, direction, size, and hardness of the obstacle TA, on the basis of the sensor data acquired in step S11. The processing advances from step S12 to step S13.

In step S13, the sensor unit 11 determines a sound image localization filter coefficient and a hardness filter coefficient on the basis of the distance, direction, size, and hardness of the obstacle TA acquired in step S12. The processing advances from step S13 to step S14.

In step S14, the reproduction buffer 17 acquires reproduction sound to be presented to the user. The processing advances from step S14 to step S15.

In step S15, the acoustic processing unit 15 performs, for the reproduction sound acquired in step S14, a filter process by a sound image localization filter having the sound image localization filter coefficient determined in step S13 and a filter process by a hardness filter having the hardness filter coefficient determined in step S13. The acoustic processing unit 15 updates the original reproduction sound of the reproduction buffer 17 with the reproduction sound obtained after the acoustic process by these filter processes. The processing advances from step S15 to step S16.

In step S16, the reproduction unit 18 converts the reproduction sound, which is obtained after the acoustic process and updated in step S15, from a digital signal into an analog signal and outputs the analog signal from the audio outputting device such as the earphones.

According to the acoustic processing apparatus 1 described above, since the user is notified of the importance of the recognition of the obstacle TA by reproduction sound to which an acoustic effect according to the hardness of the obstacle TA has been given, the user can judge whether or not danger avoidance or the like is needed. Not only to a visually handicapped person but also to a sighted person who is prone to be careless ahead while using its smartphone or while reading, beneficial information relating to the obstacle TA is presented, and besides, notification by reproduction sound that is natural and not annoying is performed.

### Description of Filter Process for Reproduction Sound

The acoustic processing unit 15 performs, for the reproduction sound stored in the reproduction buffer 17, a filter process using a sound image localization filter of the sound image localization filter coefficient stored in the sound image localization filter coefficient storage unit 13 and a hardness filter of the hardness filter coefficient stored in the hardness filter coefficient storage unit 14. By this filter process, reproduction sound to which an acoustic effect has been given (reproduction sound obtained after the acoustic process) is generated.

As described hereinabove, a filter coefficient is a data string of digital values obtained after every sampling period T of a function of time (impulse response) obtained by performing inverse Fourier transform of a frequency function (transfer function) indicative of a frequency characteristic of a filter. The filter process for the reproduction sound corresponds to a process of convolution integral of the reproduction sound and an impulse response of the filter (filter coefficient) and a process of multiplication of same frequency components of the reproduction sound and the frequency characteristic (transfer function) of the filter.

### Sound Image Localization Filter

The sound image localization filter gives, to the reproduction sound, an acoustic effect of causing the distance, direction, and size of the obstacle TA, that is, a three-dimensional position at which the obstacle TA detected by the sensor unit 11 exists, to be perceived as the position of a sound image. The sound image localization filter coefficient of the sound image localization filter may be calculated by any method.

As an example of a method for calculating the sound image localization filter coefficient of the sound image localization filter, the sound image localization filter coefficient can be calculated by theoretically determining a transfer function of propagation paths of sound between the three-dimensional position at which a sound image is to be formed and the right ear and left ear of the user and performing inverse Fourier transform of the transfer function. In particular, the filter coefficient determination unit 12 detects the three-dimensional position of the obstacle TA from the distance and direction of the obstacle TA detected from the sensor data from the sensor unit 11. In a case where the obstacle TA is large or in a like case, not one but multiple positions (detection points) may be detected as the three-dimensional position of the obstacle TA. The number of detection points may be changed according to the size of the obstacle TA. The number of detection points may alternatively be one irrespective of the size of the obstacle TA.

The filter coefficient determination unit 12 theoretically calculates, assuming the detected three-dimensional position of the obstacle TA, namely, the three-dimensional position of the detection point, as the position of a sound image (sound source), the transfer function of the propagation paths of sound from the position of the sound image to the positions of the right ear and left ear of the user. The transfer function has a transfer function (R) for the right (for the right ear) and a transfer function (L) for the left (for the left ear). In a case where the transfer function (R) and the transfer function (L) are not particularly distinguished from each other, each of them is referred to merely as a transfer function. The position of an ear of the user may be determined assuming that the position of the sensor unit 11 is the position of the head of the user.

The filter coefficient determination unit 12 performs inverse Fourier transform of the calculated transfer function (R) and transfer function (L) to calculate a sound image localization filter coefficient (R) of the sound image localization filter (R) for the right (for the right ear) and a sound image localization filter coefficient (L) of the sound image localization filter (L) for the left (for the left ear). In a case where there are multiple detection points, multiple sets of sound image localization filter coefficient (R) are calculated for the sound image localization filter (R). Also for the sound image localization filter (L), multiple sets of sound image localization filter coefficient (L) are calculated. In a case where there are multiple detection points, as one example, the acoustic processing unit 15 sets the average or the sum total of the reproduction sound (R) filter-processed by the multiple sound image localization filters (R), as the reproduction sound (R) obtained after the acoustic process (this similarly applies to the reproduction sound (L)). As another example, the filter coefficient determination unit 12 sets the average or the sum total of the multiple sets of sound image localization filter coefficient (R) as the sound image localization filter coefficient (R) of one sound image localization filter (R) (this similarly applies to the sound image localization filter coefficient (L)). As a further example, the filter coefficient determination unit 12 sets the average or the sum total of the multiple transfer functions (R) for the multiple detection points as one transfer function (R) and calculates the sound image localization filter coefficient (R) of one sound image localization filter (R) from the one transfer function (R) (this similarly applies to the transfer function (L)).

The acoustic processing unit 15 performs, for the reproduction sound (R) stored in the reproduction buffer 17, a filter process using the sound image localization filter (R) of the sound image localization filter coefficient (R) stored in the sound image localization filter coefficient storage unit 13, to calculate the reproduction sound (R) obtained after the acoustic process. The acoustic processing unit 15 updates (overwrites) the original reproduction sound (R) of the reproduction buffer 17 with the calculated reproduction sound (R) obtained after the acoustic process (this similarly applies to the reproduction sound (L)). It is to be noted that, in the present technology, the acoustic processing unit 15 may perform, for the reproduction sound, a filter process using a sound image localization filter determined by any method, may perform a filter process with a filter of another type together with the sound image localization filter or in place of the sound image localization filter, or may not perform a filter process using a sound image localization filter.

### Hardness Filter

The hardness filter gives an acoustic effect of causing the user to perceive the hardness of the obstacle TA to reproduction sound. The hardness filter coefficient of the hardness filter can be calculated, for example, in the following manner.

The hardness filter coefficient can be calculated by performing inverse Fourier transform of a transfer function of a frequency characteristic according to the hardness of the obstacle TA detected from sensor data from the sensor unit 11. As the sensor for detecting the hardness, for example, an ultrasonic sensor is included in the sensor unit 11.

The ultrasonic sensor includes a speaker that radiates an ultrasonic pulse (signal) as an inspection wave at predetermined time intervals (in a predetermined period) into a space and another speaker that detects an ultrasonic wave returning from the space (ultrasonic impulse response signal: hereinafter referred to as an ultrasonic IR). Each of the speakers includes, for example, a speaker (R) for the right and a speaker (L) for the left installed in the earphone (R) to be worn on the right ear of the user and the earphone (L) to be worn on the left ear, respectively. From the speaker (R), an ultrasonic pulse is radiated to a range of a wide directivity angle centered at a rightward center axis of the head of the user. From the speaker (L), an ultrasonic pulse is radiated to a range of a wide directivity angle centered at a leftward center axis of the head of the user. However, the speakers of the ultrasonic sensor may be disposed at portions other than the ears, and also the number of speakers may be other than two. In the following description, in a case where the speaker (R) and the speaker (L) of the ultrasonic sensor are not particularly distinguished from each other, each of them is referred to merely as a speaker. For example, the sensor unit 11 may be configured such that a single ultrasonic transceiver is disposed at a front frame portion of eyeglasses. In this case, the azimuth of the sound source is fixed at the front, and the distance and the hardness acquired from the sensors are reflected on the acoustic effect.

The ultrasonic pulse radiated from the speaker by the ultrasonic sensor includes an ultrasonic signal, for example, in an ultrasonic frequency band of 85 kHz to 95 kHz and has a pulse width of approximately 1 ms.

A microphone of the ultrasonic sensor receives an ultrasonic IR returning when an ultrasonic pulse radiated into the space from the speaker is reflected (scattered) by a physical body disposed in the space, for example, stereoscopically.

The microphone includes a microphone (R) for the right and a microphone (L) for the left disposed, for example, at the earphone (R) and the earphone (L), respectively. The microphone (R) mainly receives an ultrasonic IR that is based on the ultrasonic pulse radiated from the speaker (R) of the ultrasonic sensor. The ultrasonic IR received by the microphone (R) is referred to as an ultrasonic IR (R). The microphone (L) mainly receives an ultrasonic IR that is based on the ultrasonic pulse radiated from the speaker (L) of the ultrasonic sensor. The ultrasonic IR received by the microphone (L) is referred to as an ultrasonic IR (L).

However, the microphones for receiving an ultrasonic IR may be disposed at portions other than the ears, and also the number of microphones may be other than two. In the following description, in a case where the microphone (R) and the microphone (L) of the ultrasonic sensor are not particularly distinguished from each other, each of them is referred to simply as a microphone. In a case where the ultrasonic IR (R) and the ultrasonic IR (L) are not particularly distinguished from each other, each of them is referred to simply as an ultrasonic IR.

It is to be noted that the speakers and the microphones of the ultrasonic sensor may be connected for communication by wired or wireless connection to the main body of the acoustic processing apparatus 1, as with the audio outputting device.

The filter coefficient determination unit 12 acquires an ultrasonic IR received by the microphones of the ultrasonic sensor of the sensor unit 11, as sensor data from the sensors for detecting the hardness of the obstacle TA. The filter coefficient determination unit 12 detects the hardness of the obstacle TA on the basis of the ultrasonic IR from the ultrasonic sensor and determines a frequency characteristic (transfer function) of the hardness filter.

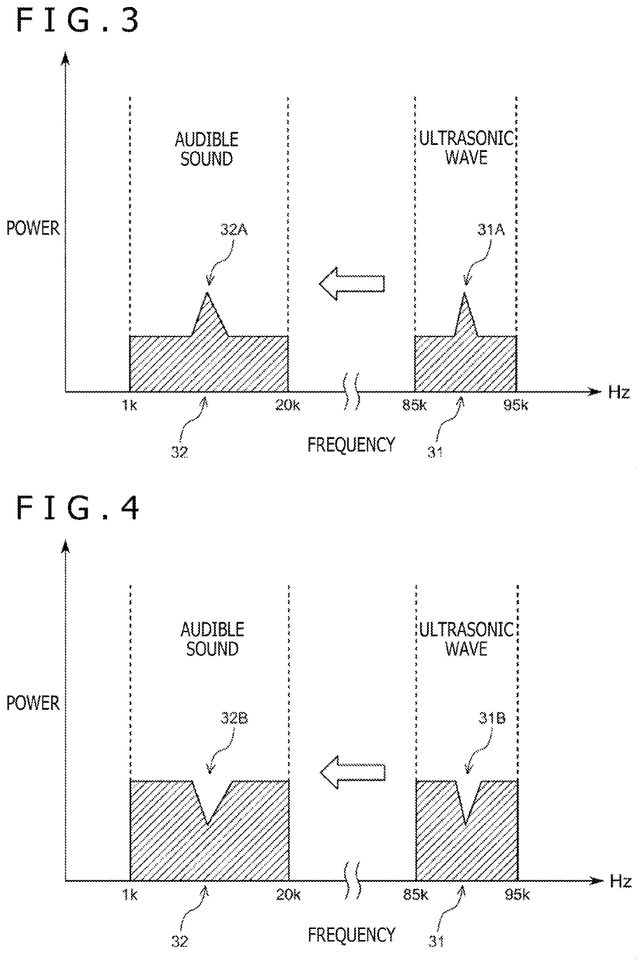

FIGS. 3 and 4 are diagrams exemplifying the frequency characteristic (transfer function) of the hardness filter in a case where the obstacle TA is hard and another case where the obstacle TA is soft.

FIG. 3 represents the frequency characteristic in the case where the obstacle TA is hard, and FIG. 4 represents the frequency characteristic in the case where the obstacle TA is soft. In FIGS. 3 and 4, the axis of abscissa represents the frequency, and the axis of ordinate represents the power.

In FIG. 3, an ultrasonic IR spectrum 31 represents frequency components of, for example, 85 kHz to 95 kHz of an ultrasonic IR acquired from the ultrasonic sensor by the filter coefficient determination unit 12, in a case where the obstacle TA is hard like metal or glass. The ultrasonic IR spectrum 31 includes a mountain-shaped spectrum 31A that indicates a peak at a predetermined frequency, in the case where the obstacle TA is hard. It is to be noted that the mountain-shaped spectrum 31A actually has a sharp peak like a line spectrum.

In FIG. 4, an ultrasonic IR spectrum 31 represents frequency components of, for example, 85 kHz to 95 kHz of an ultrasonic IR acquired from the ultrasonic sensor by the filter coefficient determination unit 12, in a case where the obstacle TA is soft like a person. The ultrasonic IR spectrum 31 includes a valley-shaped spectrum 31B (notch) that indicates a valley bottom at a predetermined frequency, in the case where the obstacle TA is soft.

The filter coefficient determination unit 12 performs frequency conversion (Fourier transform) of an ultrasonic IR obtained from the ultrasonic sensor from a time domain representation into a frequency domain representation to acquire the ultrasonic IR spectrum 31. As a result, in the case where the ultrasonic IR spectrum 31 includes such a mountain-shaped spectrum 31A as depicted in FIG. 3, the filter coefficient determination unit 12 decides that the obstacle TA is hard (high in degree of hardness). In the case where the ultrasonic IR spectrum 31 includes such a valley-shaped spectrum 31B as depicted in FIG. 4, the filter coefficient determination unit 12 decides that the obstacle TA is soft (low in degree of hardness). In a case where the ultrasonic IR spectrum 31 does not include any of the mountain-shaped spectrum 31A and the valley-shaped spectrum 31B, the filter coefficient determination unit 12 decides that the obstacle TA has medium hardness (medium in degree of hardness).

It is to be noted that the filter coefficient determination unit 12 may decide that, the greater the height of the mountain-shaped spectrum 31A (height from the foot to the peak (apex) of the mountain-shaped spectrum 31A) or the larger the value of the peak of the mountain-shaped spectrum 31A, the higher the degree of hardness, and may decide that, the deeper the depth of the valley-shaped spectrum 31B (height from the valley bottom to the top end of the valley of the valley-shaped spectrum 31B) or the smaller the value of the valley bottom of the valley-shaped spectrum 31B, the lower the degree of hardness. It is to be noted that, simply, it is also possible to index the hardness of the obstacle TA by such a criterion that, if the sound pressure of an ultrasonic reception wave is high, the hardness is high, but if the sound pressure is low, the hardness is low. In this case, since a restriction that the material and direction of the obstacle TA of the detection target are uniform to a certain degree within the ultrasonic wave radiation range is necessary, the ultrasonic wave may be radiated with the radiation angle thereof narrowed like a beam.

The filter coefficient determination unit 12 sets the frequency characteristic (transfer function) of the hardness filter such that frequency components in a predetermined range of the audio frequency band (audible range) are made larger or smaller with respect to those in peripheral portions, according to the hardness (degree of hardness) of the obstacle TA. For example, as the degree of hardness of the obstacle TA increases, the height of the mountain-shaped spectrum having a peak at a predetermined frequency component in the frequency characteristic of the hardness filter is increased, and as the degree of hardness decreases, the depth of the valley-shaped spectrum having a valley bottom at a predetermined frequency component in the frequency characteristic of the hardness filter is increased. In this case, the filter coefficient determination unit 12 may shift the ultrasonic IP spectrum as an audible range spectrum in the audible range. In other words, the filter coefficient determination unit 12 may generate a hardness filter having a frequency characteristic in the audible range corresponding to the ultrasonic IR spectrum.

In FIGS. 3 and 4, an audible range spectrum 32 represents frequency components that indicate a frequency characteristic of the hardness filter. The audible range spectrum 32 represents frequency components obtained when the spectrum structure of the ultrasonic IR spectrum 31 of 85 kHz to 95 kHz is shifted as a spectrum structure of, for example, 1 kHz to 20 kHz in the audible range. According to this, the mountain-shaped spectrum 31A in the ultrasonic IR spectrum 31 of FIG. 3 appears as a mountain-shaped spectrum 32A in the audible range spectrum 32. The valley-shaped spectrum 31B in the ultrasonic IR spectrum 31 of FIG. 4 appears as a valley-shaped spectrum 32B in the audible range spectrum 32.

After the filter coefficient determination unit 12 determines a frequency characteristic (transfer function) of the hardness filter according to the hardness (degree of hardness) of the obstacle TA in this manner, it performs inverse Fourier transform of the frequency characteristic (transfer function) of the hardness filter from a frequency domain representation to a time domain representation to calculate an impulse response (audible range impulse response: audible range IR) of the hardness filter, thereby determining a hardness filter coefficient.

It is to be noted that the method by the filter coefficient determination unit 12 for determining a frequency characteristic (transfer function) of the hardness filter according to the hardness (degree of hardness) of the obstacle TA is not restricted to that descried above. For example, the filter coefficient determination unit 12 may determine the frequency characteristic such that, as the degree of hardness of the obstacle TA increases, the magnitude of the predetermined frequency components in the frequency characteristic of the hardness filter increases. Since the width of the mountain-shaped spectrum 31A and the valley-shaped spectrum 31B of the ultrasonic IR spectrum 31 increases as the size of the obstacle TA increases, it is also possible to detect the size of the obstacle TA on the basis of the ultrasonic IR spectrum 31. The filter coefficient determination unit 12 may increase the width, which is to be changed according to the hardness, of the predetermined frequency components in the frequency characteristic of the hardness filter as the size of the obstacle TA increases. In the case where the ultrasonic IR spectrum 31 is to be shifted as an audible range spectrum 32 in the audible range, the magnitude of the width of the mountain-shaped spectrum 31A and the valley-shaped spectrum 31B of the ultrasonic IR spectrum 31 is reflected as it is as the magnitude of the width of the mountain-shaped spectrum 32A and the valley-shaped spectrum 32B in the audible range spectrum 32 in the audible range. Accordingly, the size of the obstacle TA is also reflected on the hardness filter.

The filter coefficient determination unit 12 acquires an ultrasonic IR (R) and an ultrasonic IR (L) from the ultrasonic sensor of the sensor unit 11 and determines a hardness filter coefficient of the hardness filter for each of them. Accordingly, the hardness filter includes a hardness filter (R) of a hardness filter coefficient (R) determined based on the ultrasonic IR (R) and a hardness filter (L) of a hardness filter coefficient (L) determined based on the ultrasonic IR (L). The filter coefficient determination unit 12 causes the determined hardness filter coefficient (R) of the hardness filter (R) and the determined hardness filter coefficient (L) of the hardness filter (L) to be stored into the hardness filter coefficient storage unit 14. It is to be noted that, in a case where the hardness filter (R) and the hardness filter (L) are not particularly distinguished from each other, each of them is referred to simply as a hardness filter. It is to be noted that, in a case where the hardness filter coefficient (R) and the hardness filter coefficient (L) are not particularly distinguished from each other, each of them is referred to simply as a hardness filter coefficient.

The acoustic processing unit 15 reads out the reproduction sound (R) accumulated in the reproduction buffer 17 and performs a filter process for the read out reproduction sound (R) with use of the hardness filter (R) of the hardness filter coefficient (R) stored in the hardness filter coefficient storage unit 14 to calculate reproduction sound (R) obtained after the acoustic process. The acoustic processing unit 15 similarly performs a filter process also for the reproduction sound (L) with use of the hardness filter (L) of the hardness filter coefficient (L) to calculate reproduction sound (L) obtained after the acoustic process.

It is to be noted that the acoustic processing unit 15 performs, from between the filter process by the sound image localization filter and the filter process by the hardness filter, the former first. Accordingly, the reproduction sound read out from the reproduction buffer 17 when the filter process by the hardness filter is to be performed by the acoustic processing unit 15 is reproduction sound filter-processed by the sound image localization filter. However, the acoustic processing unit 15 may perform the filter process by the hardness filter prior to the filter process by the sound image localization filter.

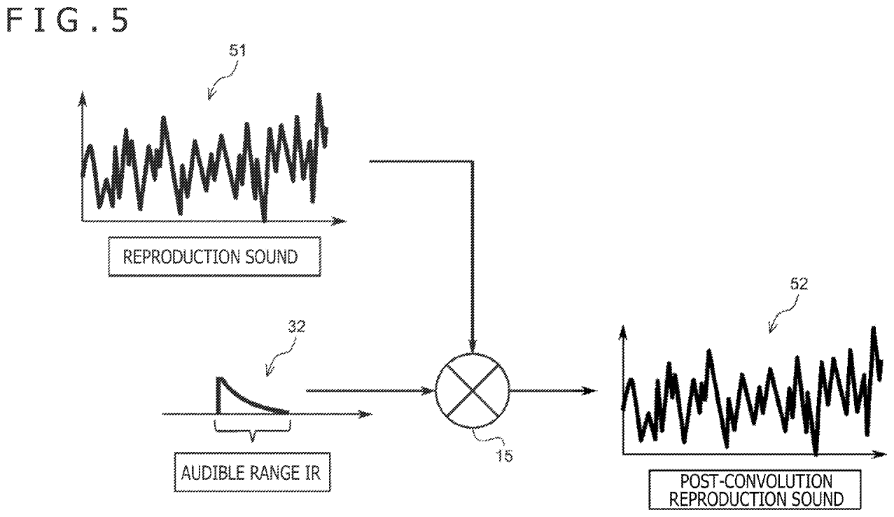

FIG. 5 is a diagram illustrating the filter process by the hardness filter.

In FIG. 5, an audible range IR 32 is an impulse response signal of the hardness filter represented by the filter coefficient of the hardness filter. Since the audible range IR 32 corresponds to the impulse response of the hardness filter obtained by converting (performing inverse Fourier transform of) the audible range spectrum 32 (transfer function) of the hardness filter in FIGS. 3 and 4 from a frequency domain representation to a time domain representation, it is represented by a reference sign same as that of the audible range spectrum 32.

Reproduction sound 51 represents a reproduction sound signal read out from the reproduction buffer 17 to the acoustic processing unit 15.

Post-convolution reproduction sound 52 represents a reproduction sound signal which is obtained after an acoustic process and which has been filter-processed by the hardness filter.

The acoustic processing unit 15 performs a process of convolution integral for the audible range IR 32 of the hardness filter based on the hardness filter coefficient acquired from the hardness filter coefficient storage unit 14 and the reproduction sound 51 read out from the reproduction buffer 17, to calculate post-convolution reproduction sound 52 as the reproduction sound obtained after the acoustic process. It is to be noted that, for the process of convolution integral, various methods are known and any method may be used.

The acoustic processing unit 15 updates (overwrites) the original reproduction sound (R) of the reproduction buffer 17 with the calculated reproduction sound (R) obtained after the acoustic process (this similarly applies to the reproduction sound (L)).

According to the filter process for reproduction sound described above, since reproduction sound to which an acoustic effect according to the hardness (and the size) of the obstacle TA has been given is generated, the user is notified of the importance of the recognition of the obstacle TA. The user can judge whether or not danger avoidance or the like is needed. Not only to a visually handicapped person but also to a sighted person who is prone to be careless ahead while using its smartphone or while reading, beneficial information relating to the obstacle TA is presented, and besides, notification by reproduction sound that is natural and not annoying is performed.

It is to be noted that the filter process by the hardness filters having different hardness filter coefficients may be performed for each of the reproduction sound (R) and the reproduction sound (L) to be presented to the user, but alternatively, the filter process by the same hardness filter may be performed for the reproduction sound (R) and the reproduction sound (L). In this case, the filter coefficient determination unit 12 determines the hardness filter coefficient on the basis of one ultrasonic IR. The filter coefficient determination unit 12 may detect the hardness of the obstacle TA on the basis of sensor data obtained from a sensor other than the ultrasonic sensor.

### Another Method for Calculating Hardness Filter Coefficient from Ultrasonic IR

The filter coefficient determination unit 12 may calculate the hardness filter coefficient for the ultrasonic IR acquired from the ultrasonic sensor of the sensor unit 11, with use of an inference model in machine learning.

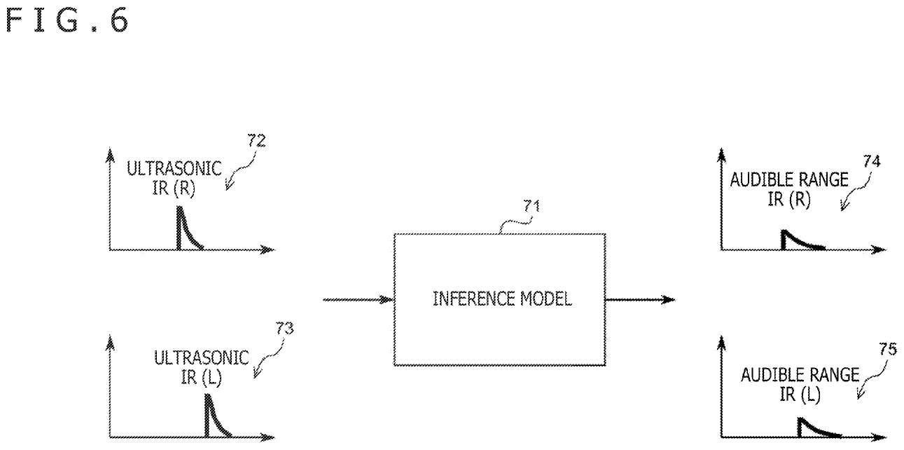

FIG. 6 is a view illustrating a case in which the filter coefficient determination unit 12 uses an inference model to calculate a hardness filter coefficient of the hardness filter.

An inference model 71 is an inference model in machine learning incorporated in the filter coefficient determination unit 12 and has, for example, a structure of a neural network. The inference model 71 is learned in advance by supervised learning.

To the inference model 71, an ultrasonic IR (R) 72 and an ultrasonic IR (L) 73 from the ultrasonic sensors of the sensor unit 11 are inputted. The inference model 71 estimates and outputs an audible range IR (R) 74 and an audible range IR (L) 75 of the hardness filter for the ultrasonic IR (R) 72 and the ultrasonic IR (L) 73 inputted thereto.

The inference model 71 is learned using a data set including a large number of pieces of learning data. Each piece of learning data includes an ultrasonic IR (L) and an ultrasonic IR (R) that are input data and an audible range IR (R) and an audible range IR (L) as correct answer data to be outputted with respect to the input data. The ultrasonic IR (L) and the ultrasonic IR (R) that are input data in the learning data are, for example, actual measurement data obtained by the ultrasonic sensors with respect to obstacles TA of various hardness values. The correct answer data in the learning data represents an ideal audible range IR (R) and an ideal audible range IR (L) of the harness filter according to the hardness of the obstacle TA at the time when actual measurement data that are the input data are obtained.

The filter coefficient determination unit 12 determines digital values obtained by extracting, in a sampling period T, the audible range IR (R) 74 and the audible range IR (L) 75 of the hardness filter outputted from the inference model 71, as the hardness filter coefficient (R) and the hardness filter coefficient (L), respectively.

In the foregoing description, the present technology may not perform a filter process by a sound image localization filter for reproduction sound.

The present technology can also be applied to a case in which, in place of generating reproduction sound according to the hardness of an obstacle TA and presenting the generated reproduction sound to a user, notification information (vibration signal) for causing the user to perceive vibration according to the hardness of the obstacle TA is generated and presented to the user. In this case, a vibration signal of a frequency whose vibration can be perceived by a person (for example, 100 Hz to 300 Hz) is used in place of a reproduction sound signal, and the frequency characteristic of the hardness filter is changed according to the hardness of the obstacle TA within the range of the frequency in which vibration can be perceived by a person. A vibrator that generates vibration is used as the reproduction unit 18, and the vibrator is placed on the body of the user or on a thing the user is to touch.

The present technology is effective in various fields. For example, the sensors of the sensor unit 11 of the acoustic processing apparatus 1 may be installed on the exterior or the like of a vehicle such as an automobile, detect the hardness of an obstacle around the vehicle, and output reproduction sound according to the hardness of the obstacle from a speaker or the like in the vehicle, or may cause vibration according to the hardness of the obstacle to be generated at a seat on which the user sits.

### Program

The series of processes in the acoustic processing apparatus 1 described above can be executed not only by hardware but also by software. In a case where the series of processes is executed by software, a program constituting the software is installed into a computer. The computer here includes a computer that is incorporated in hardware for exclusive use, a personal computer, for example, for universal use that can execute various functions by installing various programs into the personal computer, and so forth.

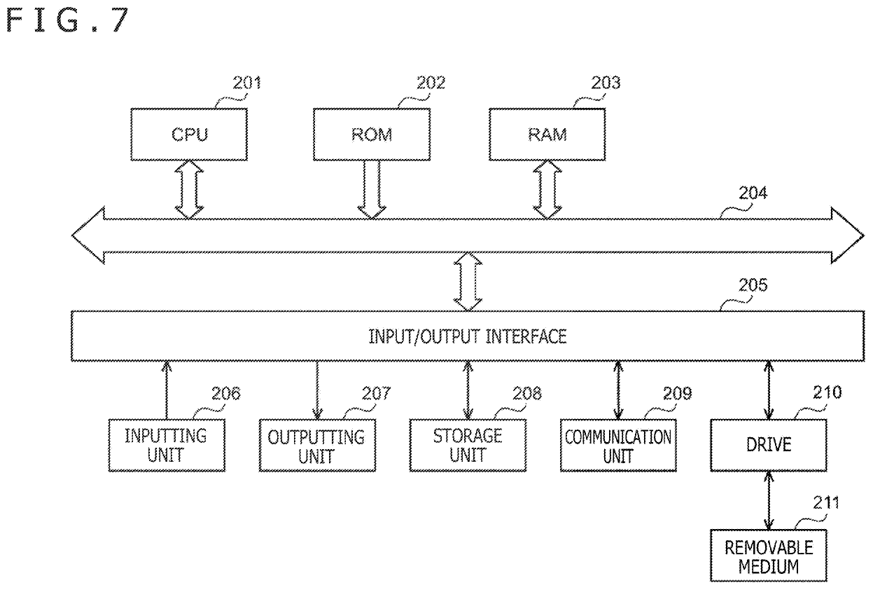

FIG. 7 is a block diagram depicting an example of a hardware configuration of a computer in a case where the processes to be executed by the acoustic processing apparatus 1 are executed in accordance with a program by the computer.

In the computer, a CPU (Central Processing Unit) 201, a ROM (Read Only Memory) 202, and a RAM (Random Access Memory) 203 are connected to one another by a bus 204.

To the bus 204, an input/output interface 205 is connected further. To the input/output interface 205, an inputting unit 206, an outputting unit 207, a storage unit 208, a communication unit 209, and a drive 210 are connected.

The inputting unit 206 includes a keyboard, a mouse, a microphone, and so forth. The outputting unit 207 includes a display, a speaker, and so forth. The storage unit 208 includes a hard disk, a nonvolatile memory, and so forth. The communication unit 209 includes a network interface and so forth. The drive 210 drives a removable medium 211 such as a magnetic disk, an optical disk, a magneto-optical disk, or a semiconductor memory.

In the computer configured in such a manner as described above, the CPU 201 loads a program stored, for example, in the storage unit 208 into the RAM 203 via the input/output interface 205 and the bus 204 and executes the program to perform the series of processes described above.

The program that is executed by the computer (CPU 201) can be recorded on and provided as the removable medium 211, for example, as a package medium or the like. Further, the program can be provided through a wired or wireless transmission medium such as a local area network, the Internet, or a digital satellite broadcast.

In the computer, the program can be installed into the storage unit 208 through the input/output interface 205 from the removable medium 211 that is mounted on the drive 210. Further, the program can be received by the communication unit 209 through a wired or wireless transmission medium and installed into the storage unit 208. Alternatively, the program can be installed in advance into the ROM 202 or the storage unit 208.

It is to be noted that the program to be executed by the computer may be a program in accordance with which the processes are carried out in a time series in the order described in the present specification or may be a program in accordance with which the processes are executed in parallel or at a necessary timing such as when they are called.

Note that the present technology can also adopt the following configurations.

(1)

An information processing apparatus including:
a processing unit that generates notification information that causes hardness of a physical body existing in a space to be perceived by a user spaced from the physical body.
   (2)

The information processing apparatus according to (1) above, in which
the processing unit generates the notification information according to the hardness of the physical body on the basis of an ultrasonic response signal returned from the space in response to a pulse signal in an ultrasonic frequency band radiated to the space.
   (3)

The information processing apparatus according to (2) above, in which
the processing unit generates the notification information in which frequency components of predetermined reproduction sound to be presented to the user are changed by a hardness filter having a frequency characteristic in an audible frequency band corresponding to a frequency spectrum of the ultrasonic response signal.
   (4)

The information processing apparatus according to (2) above, in which
the processing unit estimates, for the ultrasonic response signal, a hardness filter that has a frequency characteristic in an audible frequency band according to the hardness of the physical body by an inference model in machine learning and generates the notification information in which frequency components of predetermined reproduction sound to be presented to the user are changed by the hardness filter.
   (5)

The information processing apparatus according to any of (1) to (4) above, in which
the processing unit generates the notification information that is to be perceived through an acoustic sense of the user.
   (6)

The information processing apparatus according to any of (1) to (5) above, in which
the processing unit generates the notification information in which an acoustic effect according to the hardness of the physical body is given to predetermined reproduction sound to be presented to the user.
   (7)

The information processing apparatus according to (6) above, in which
the processing unit generates the notification information in which frequency components of the reproduction sound are changed by a hardness filter having a frequency characteristic according to the hardness of the physical body.
   (8)

The information processing apparatus according to (6) above, in which
the processing unit generates the notification information in which the acoustic effect is given to the reproduction sound by convolution integral of the reproduction sound and an impulse response of a hardness filter according to the hardness of the physical body.
   (9)

The information processing apparatus according to (7) above, in which
the processing unit changes a magnitude of a predetermined frequency component in a frequency characteristic of the hardness filter according to the hardness of the physical body.
   (10)

The information processing apparatus according to (9) above, in which
the processing unit increases the predetermined frequency component in the frequency characteristic of the hardness filter as a degree of the hardness of the physical body increases.
   (11)

The information processing apparatus according to any of (6) to (10) above, in which
the processing unit generates the notification information in which an acoustic effect of causing the user to perceive a position of the physical body as a position of a sound image is given to the reproduction sound.
   (12)

The information processing apparatus according to (1) above, in which
the processing unit generates the notification information that causes the user to perceive vibration.
   (13)

The information processing apparatus according to (12) above, in which
the processing unit generates the notification information in which frequency components of a signal of the vibration are changed by a hardness filter having a frequency characteristic according to the hardness of the physical body.
   (14)

An information processing method for an information processing apparatus including a processing unit, the information processing method including:
by the processing unit, generating notification information that causes hardness of a physical body existing in a space to be perceived by a user spaced from the physical body.
   (15)

A program for causing a computer to function as:
a processing unit that generates notification information that causes hardness of a physical body existing in a space to be perceived by a user spaced from the physical body.

### REFERENCE SIGNS LIST

1: Acoustic processing apparatus
11: Sensor unit
12: Filter coefficient determination unit
13: Sound image localization filter coefficient storage unit
14: Hardness filter coefficient storage unit
15: Acoustic processing unit
16: Reproduction supply unit
17: Reproduction buffer
18: Reproduction unit

1. An information processing apparatus comprising:
a processing unit that generates notification information that causes hardness of a physical body existing in a space to be perceived by a user spaced from the physical body.

2. The information processing apparatus according to claim 1, wherein
the processing unit generates the notification information according to the hardness of the physical body on a basis of an ultrasonic response signal returned from the space in response to a pulse signal in an ultrasonic frequency band radiated to the space.

3. The information processing apparatus according to claim 2, wherein
the processing unit generates the notification information in which frequency components of predetermined reproduction sound to be presented to the user are changed by a hardness filter having a frequency characteristic in an audible frequency band corresponding to a frequency spectrum of the ultrasonic response signal.

4. The information processing apparatus according to claim 2, wherein
the processing unit estimates, for the ultrasonic response signal, a hardness filter that has a frequency characteristic in an audible frequency band according to the hardness of the physical body by an inference model in machine learning and generates the notification information in which frequency components of predetermined reproduction sound to be presented to the user are changed by the hardness filter.

5. The information processing apparatus according to claim 1, wherein
the processing unit generates the notification information that is to be perceived through an acoustic sense of the user.

6. The information processing apparatus according to claim 1, wherein
the processing unit generates the notification information in which an acoustic effect according to the hardness of the physical body is given to predetermined reproduction sound to be presented to the user.

7. The information processing apparatus according to claim 6, wherein
the processing unit generates the notification information in which frequency components of the reproduction sound are changed by a hardness filter having a frequency characteristic according to the hardness of the physical body.

8. The information processing apparatus according to claim 6, wherein
the processing unit generates the notification information in which the acoustic effect is given to the reproduction sound by convolution integral of the reproduction sound and an impulse response of a hardness filter according to the hardness of the physical body.

9. The information processing apparatus according to claim 7, wherein
the processing unit changes a magnitude of a predetermined frequency component in a frequency characteristic of the hardness filter according to the hardness of the physical body.

10. The information processing apparatus according to claim 9, wherein
the processing unit increases the predetermined frequency component in the frequency characteristic of the hardness filter as a degree of the hardness of the physical body increases.

11. The information processing apparatus according to claim 6, wherein
the processing unit generates the notification information in which an acoustic effect of causing the user to perceive a position of the physical body as a position of a sound image is given to the reproduction sound.

12. The information processing apparatus according to claim 1, wherein
the processing unit generates the notification information that causes the user to perceive vibration.

13. The information processing apparatus according to claim 12, wherein
the processing unit generates the notification information in which frequency components of a signal of the vibration are changed by a hardness filter having a frequency characteristic according to the hardness of the physical body.

14. An information processing method for an information processing apparatus including a processing unit, the information processing method comprising:
by the processing unit, generating notification information that causes hardness of a physical body existing in a space to be perceived by a user spaced from the physical body.

15. A program for causing a computer to function as:
a processing unit that generates notification information that causes hardness of a physical body existing in a space to be perceived by a user spaced from the physical body.
